(19) United States
(12) Patent Application Publication
(10) Pub. No.: US 2010/0135287 A1
(43) Pub. Date: Jun. 3, 2010

(54) Process for prioritized end-to-end secure data protection

(76) Inventors: Akram M. Hosain, Simi Valley, CA (US); Ricardo A. Arteaga, Lancaster, CA (US)

Correspondence Address: LOUIS L. DACHS, 1794 PALISADES DRIVE, PACIFIC PALISADES, CA, 90272, US

(21) Appl. No.: 12/315,297

(22) Filed: Dec. 2, 2008

(51) Int. Cl. H04L 12/56

(52) U.S. Cl. 370/389

(57) ABSTRACT

The invention is a process for prioritizing messages from a first computer system having at least one computer connected to a first edge router to be sent to a second computer system having at least one computer connected to a second edge router, the process includes the steps of: 1) providing priority status from the at least one first computer to the at the first edge router; 2) determining the priority status of the message by the first edge router; 3) prioritizing the sending of the message by the first edge router; 4) encrypting the priority status prior to sending the message to the at least one second computer a the selected priority status; and 5) upon receiving the encrypted message, the second edge router decrypts the priority status of the message and sends it to the at least one second computer at the selected priority status.

### BACKGROUND OF INVENTION

1. Field of Invention

The present invention relates to a process for securing control and user data in communication systems and, in particular, to a process wherein encrypted priority information is included in the transmission of the data through the communication system.

2. Description of Related Art

Streaming video communications over packet-based networks are becoming more common within communications systems. Currently, many of these networks are Internet Protocol (IP) networks. The use of these networks for communications takes advantage of resources already in place. Further, entities with Internet systems also may implement streaming video communications using their existing network systems. Further, in addition to streaming video, the presence of a packetbased network allows for various services to be offered based on the packetbased technologies, such as, for example, providing e-mail messages, ISR video, chat and documents across the same terminal device. A packet-based network system used for streaming video is the fact that IP networks, such as the Internet, consists of multiple routers (i.e. edge and core), which are linked together. These routers store the data and forward them to the most appropriate output links.

IP is a datagram-based approach and offers no guarantee of quality of service. For example, network delays may be variable depending on the traffic within the network. In an IP network, packets are self-routed and dependant on the IP address. As a result, packets may take different routes depending on how busy each router is within a network. In contrast, with a fixed circuit, the delay is fixed and deterministic. A further problem with IP networks is that depending on the traffic within a network, packets may be dropped. As a result, the packets retransmitted are delayed more than other packets taking the same route, which have not been dropped. This retransmission mechanism is appropriate for applications, which are insensitive to delays. These mechanisms are commonly used in applications, such as, for example, Web browsers and e-mail programs.

Conversely with delay sensitive applications, variable delays and dropping of packets are undesirable. When the delay sensitive application includes transmitting streaming video data, variable delay or dropping of packets is unacceptable to maintain an appropriate quality of service for a call. Another instance in which the unpredictable delay or dropping of packets is unacceptable occurs as with user data messages used to set up, manage, and terminate a session for a call. Currently, no mechanism is present for handling control and user data messages over a packet-based network to guarantee delivery of these messages where these packets are secure via encryption or other cryptographical methods, where data is obscure. Therefore, it would be valuable to have an improved method, apparatus, and system for handling control and user data messages in an IP communications system, where the data is secure by means of cryptography. The proposed ToS/QoS mechanism affords a guaranteed service in the reception of the higher priority messages 99 percent of the time using cryptographic security protocols.

U.S. Pat. No. 7,106,718 describes a signaling bearer quality of service profile is pre-established and configured in various nodes in an access network. This is a new quality of service class designed to meet the needs of signaling bearers in multimedia sessions.

U.S. Pat. No. 7,027,457, Method And Apparatus For Providing Differentiated Quality-of-Service Guarantees In Scalable Packet Switches by F. M. Chiussi, et al. describes an invention comprises a method and apparatus for providing differentiated Quality-of-Service (QoS) guarantees in scalable packet switches. The invention advantageously uses a decentralized scheduling hierarchy to regulate the distribution of bandwidth and buffering resources at multiple contention points in the switch, in accordance with the specified QoS requirements of the configured traffic flows.

U.S. Pat. No. 6,970,470 Packet Communication System with QOS Control Function by T. Yuzaki, et al. describes a packet communication system of the present invention has first mode, second mode and third mode to apply to input packets. U.S. Pat. No. 6,865,153 Stage-implemented QOS Shaping for Data Communication Switch by R. Hill, et al. describes a stage-implemented QoS shaping scheme is provided for a data communication switch. U.S. Pat. No. 6,850,540 Packet Scheduling in A communication System by J. J. Pelsa, et al. describes methods, systems, and arrangements enable packet scheduling in accordance with quality of service (QoS) constraints for data flows. U.S. Pat. No. 6,640,248 Application-Aware Quality of Service (QOS) Sensitive, Media Access Control (MAC) Layer by J. W I Jorgensen describes an application aware, quality of service (QoS) sensitive, media access control (MAC) layer includes an application-aware resource allocator, where the resource allocator allocates bandwidth resource to an application based on an application type. U.S. Pat. No. 7,123,598 Efficient QOS Signaling for Mobile IP using RSVP Frame Work by H. M Chaskar describes a system and method for efficient QoS signaling for mobile IP using RSVP framework in which mobile nodes are connected to correspondent nodes via plurality of intermediate nodes.

Thus, it is a primary purpose of the invention to provide a process in a communication system wherein the priority of the data is securely transmitted. This priority is taking place in various layers of the protocols from source host (i.e. computer, PDA, electronic device, etc) to the destination host along the edge and core routers.

It is another primary purpose of the invention to provide a process in a communication system wherein the priority of the data transmission is encrypted, wherein a priority indicator is provided by a signaling protocol.

### SUMMARY OF INVENTION

The present invention provides a process in a communication system for control and user data for a session in a packet-based network within the communications system where the data is encrypted. An encrypted priority indicator is placed or derived from other sources in a user data message handling a session within the communications system through the packet-based network via a signaling protocol. Applications handling user data messages in the packet-based network will provide priority or preferential handling of the secure user data messages. The main advantage of this invention is to guarantee that higher priority data will be received at the other end (destination host) before lower priority data at least 99 percent of the time in a secure manner.

In detail, the process for prioritizing messages from a first computer system having at least one computer connected to a first edge router to be sent to a second computer system having at least one computer connected to a second edge router, the process includes the steps of:
1. Providing priority status from the at least one first computer to the at the first (source host) edge router;
2. Determining the priority status of the message by the first edge router (source edge router);
3. Prioritizing the sending of the message by the first (source) edge router;
4. Encrypting the priority status prior to sending the message to the at least one second (destination host) computer at the selected priority status; and
5. Upon receiving the encrypted message, the second (destination) edge router decrypts the priority status of the message and sends it to the at least one second (destination host) computer at the selected priority status.
   The priority status is encrypted by the at least first (source host) computer; and/or the first (source) edge router, which is de-crypts by the core or destination edge router to determine priority status of the packet.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1, is a diagram of Classification, Conditioning & Forwarding, which shows an instance of the system of how end-to-end priority based routing is achieved.

FIG. 2, is a protocol chart of QoS in an airborne network protocol stack showing one instance of communication protocols between an airborne computer and a Global Information Grid (GIG) computer.

FIG. 3, is a time sequence diagram of NSLP end-to-end data flow, showing the control and users data are transmission between two or more separate domains while providing the preferential treatment to the higher priority packets.

FIG. 4 is a flow chart illustrating, ToS/QoS processing, in particular how input and output queues will be processed for priority queues at various layers of the network protocols.

FIGS. 5A & 5B are flow charts of a multilevel priority queue processing wherein frames/message/packets with various priorities will be processed within various layers of network protocol.

FIG. 6, is a flow chart of a admission control (policing) algorithm, which shows the policy about packet dropping algorithms when the resource bandwidth utilization reaches a predefined or dynamic threshold.

FIGS. 7A & 7B, show a pictorial representation of QoS relevant IP fields with important IP fields, which play an active role in this priority based secure information processing.

FIGS. 8A & 8B, are diagrams of QoS supported by differentiated services which shows (in the top part) how the QoS/ToS is being mapped to the DS field and (in the bottom part) show how a packet, which is not marked properly, will be marked and processed/dropped.

FIGS. 9A, 9B and 9C show the steps of a secure end-to-end data protection including ToS/QoS showing how a secured packet will be traversed through the network while maintaining the priority based processing treatment.

FIG. 10, is diagram of core router functionality showing control message processing.

FIG. 11, is diagram of a core router functionality showing user data message processing.

FIGS. 12A & 12B, are diagrams of a edge router functionality showing incoming side (intranet) to outgoing side (Internet) and Internet to intranet message processing.

### DESCRIPTION OF THE PREFERRED EMBODIMENT

Following is a list of acronyms used, which are used throughout the description of the preferred embodiment:
ACL Access Control List
AH Authentication Header
AVT Audio/Video Transport
Black side The side of the edge router which interfaces with the computer
CCIO Crypto-Contract Control Idenification
CNO Computer Network Operation
DSCP Differentiated Service Code Point
DiffServ Differentiated service
ESP Encapsulated Secure Protocol
GIG Global Internet Grid
HAIPE High Assurance Internet Protocol Encryptor
Host Computer, Laptop, PDA, etc,
INFOSEC Information Security
IPTel IP Telephony
IPv6 IP Version 6
IPv4 IP Version 4
ISR Intelligence, Surveillance and Reconnaissance
LAN Local area network
LLQ Low Latency Queuing
MIPv6 Mobility for IPv6
NSIS Next Step in Signaling
NSLP Signaling Layer Protocol
PDR Per Domain Reservation
PHB-AF Per-Hop Behavior—Assured Forwarding
PHB-BE Per-Hop Behavior—Best Effort
PHB-EF Per-Hop Behavior—Expedited Forwarding
PHR Per Hop Reservation
QNE An NSIS Entity (NE), which supports the QoS NSLP.
QNI The first node in the sequence of QNEs that issues a reservation request for a session.
QNR The last node in the sequence of QNEs that receives a reservation request for a session.
QoS: Quality of Service
QSpec: Quality Specification
Red Side The side of the router which interfaces with core routers
RFC Request for Comments
RJ45 Short for Registered Jack45, an eight-wire connector used commonly to connect computers onto a LAN, especially Ethernets.
RMD Resource Management in Differentiated service
RSVP Resource Reservation Protocol
RTP Real-time Transport Protocol
Session ID This is a cryptographically random and (probabilistically) globally unique identifier of the application layer session that is associated with a certain flow.
SLA Service Level Agreement
TC Traffic Class
TCP: Transport Layer Protocol
ToS: Type of Service
UDP User Datagram Protocol

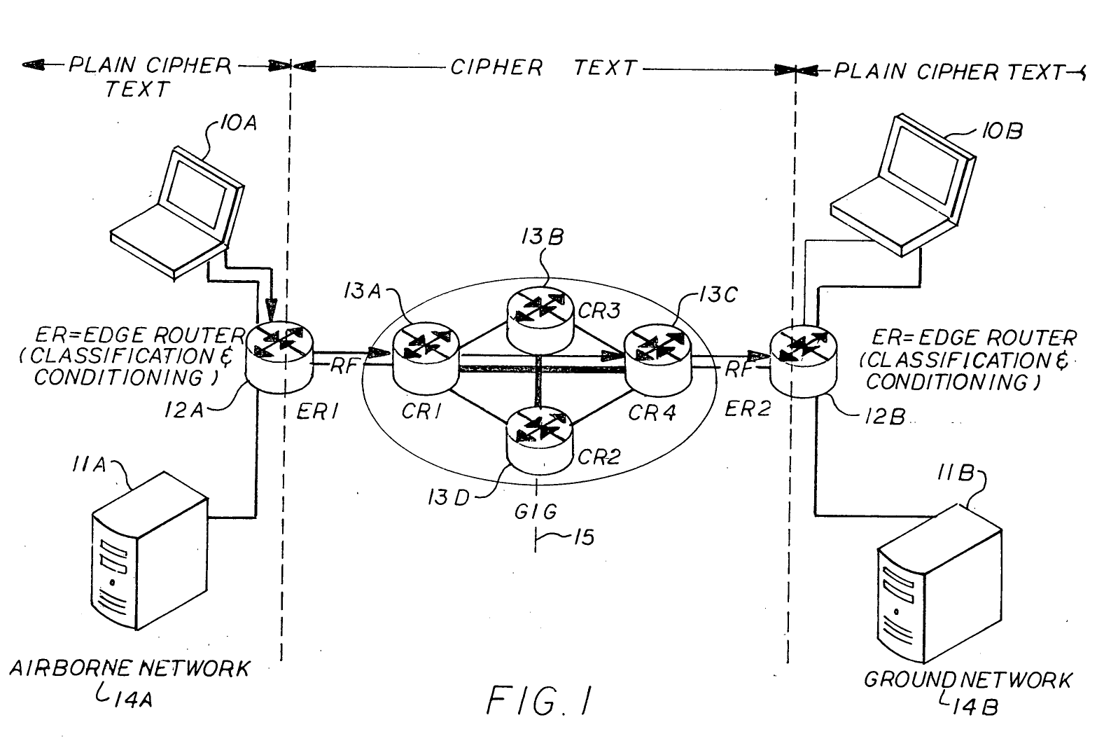

Referring to FIG. 1, which is an example of computer network operation (CNO) showing a high level view of end-to-end priority based secure routing. The Edge Routers 12A, and 12B perform the classification and conditioning. The computers 10A, and 11A are located in one Local area network (LAN) 14A; and the computers 10B, and 11B are located in second LAN 14B. The Core Routers 13A, 13B, 13C, and 13D are located in the Global Information Grid (GIG) 15. Edge Routers 12A, and 12B are located in between the GIG 15 and the LANS 14A and 14B. Packets are marked in the type of service (ToS) in IPv4, or traffic class (TC) in IPv6 field at the edge routers 12A and 12B. Differentiated Services 6 bits field is used for Differentiated Service Code Point (DSCP), which determines Per-Hop Behavior that the packet will receive is mapped earlier from ToS/TC field. Also edge routers 12A, and 12B may meter and shape non-conforming traffic packets. The packet forwarding function is provided by the core routers 13A, 13B, 13C, and 13D.

For example the core routing provides the following services to the packets.
1. Expedited Forwarding—departure rate of packets from a class equals or exceeds a specified rate (logical link with a minimum guaranteed rate).
2. Assured Forwarding—4 classes of service, each guaranteed a minimum amount of bandwidth and buffering.
3. Best-Effort Forwarding—treats packet as normal.

Control and user data flow through packet-based routers is depicted in accordance with a preferred embodiment of the present invention. In some cases, control and user data messages may be routed through nodes (i.e. IP or other router, wireless nodes), which do not contain applications to control the flow of messages. For example, within an IP network, messages may be placed into IP packets for routing from a source to a destination through a number of different nodes, such as routers. These routers do not examine the user data messages themselves, but route the data based on the headers in the IP packets. In this example, IP layer generates IP packets containing data for user data messages and sends them to IP layer. These IP layers may be located in a same LAN and/or a separate LAN.

In this case, the path between these computers 10A, 10B, 11A, and 11B passes through routers (preferably HAIPE type) 12A, 12B, 13A, 13B, 13C, and 13D. These routers, do not examine the user data messages, but process the IP packets based on the information in the headers of the IP packets along with the QoS information received via signaling protocol such as RMD for DiffServ. IP layer is instructed through a call or some other mechanism to set an indicator to provide priority handling of the IP packets. When an IP packet is received by routers 12A, 12B, 13A, 13B, 13C, and 13D, the header of the IP packet is examined. In addition to identifying where to send the IP packet, a determination is made as to whether an indicator is set in the header of the IP packet to identify whether the IP packet is to be given priority in processing. If an indicator is set in the header, then that IP packet is processed prior to other IP packets without the indicator. For example, an IP packet containing the indicator will be placed in a processing queue prior to other packets without an indicator. In this manner, priority handling of packets containing user data messages may be obtained even in nodes, which do not contain applications that examine the user data messages themselves.

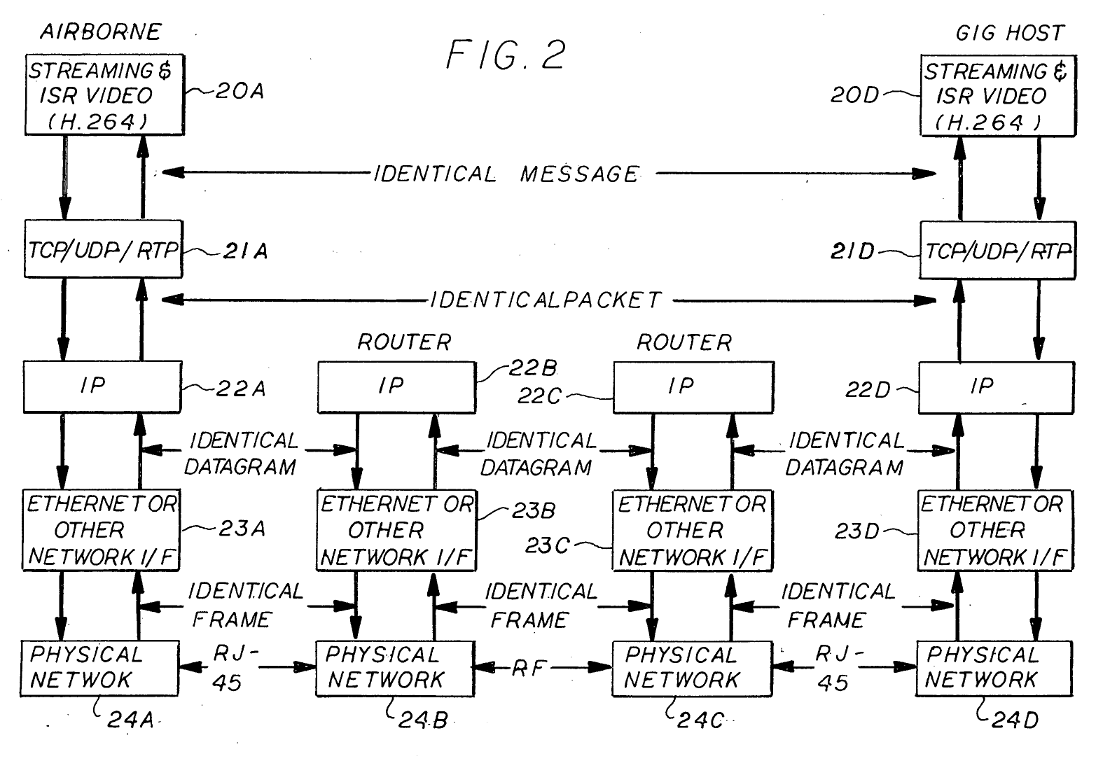

Referring to FIG. 2, wherein a protocol stack is depicted in accordance with a preferred embodiment of the present invention. In this example, the protocol stack includes an application/presentation/session layer 20A, and 20B; a transport layer 21A, and 21B; a network layer 22A, 22B, 22C, and 22D; a data link layer 23A, 23B, 23C, and 23D; and a physical layer 24A, 24B, 24C, and 24D; between two end points 20A, and 20B. In the depicted example, protocol stack is located in nodes with an application that handles control and user data messages.

The mechanism of the present invention is implemented in application layer 20A, and 20B; network layer 22A, 22B, 22C, and 22D; and the data link layer 23A, 23B, 23C, and 23D. An application program, i.e. streaming Video in application layer 20A, and 20B may generate or receive user data messages. When generating a user data message, the application includes an indicator to provide priority processing by an application receiving the user data message. Further, the application in the node generating the message may send a call or command to network layer to provide for priority or precedence handling of IP packets containing the user data message. Further, the network layer in the node generating the message may send a call or command to link layer to provide for priority or precedence handling of IP packets containing the user data packet. In this example, network layer includes an IP protocol. In response to receiving a request to provide priority or precedence handling for a user data message being transported using one or more IP packets, the headers of these IP packets will include an indicator used by other network layers located in nodes routing IP packets to provide priority or precedence in the processing of these IP packets.

In this manner, when user data messages are routed by nodes that do not examine the user data messages in routing the messages, priority in the handling of these messages is insured between a host and an edge router. Between one edge router to another edge router, RMD for differential server is used to sending priority information in an encrypted manner.

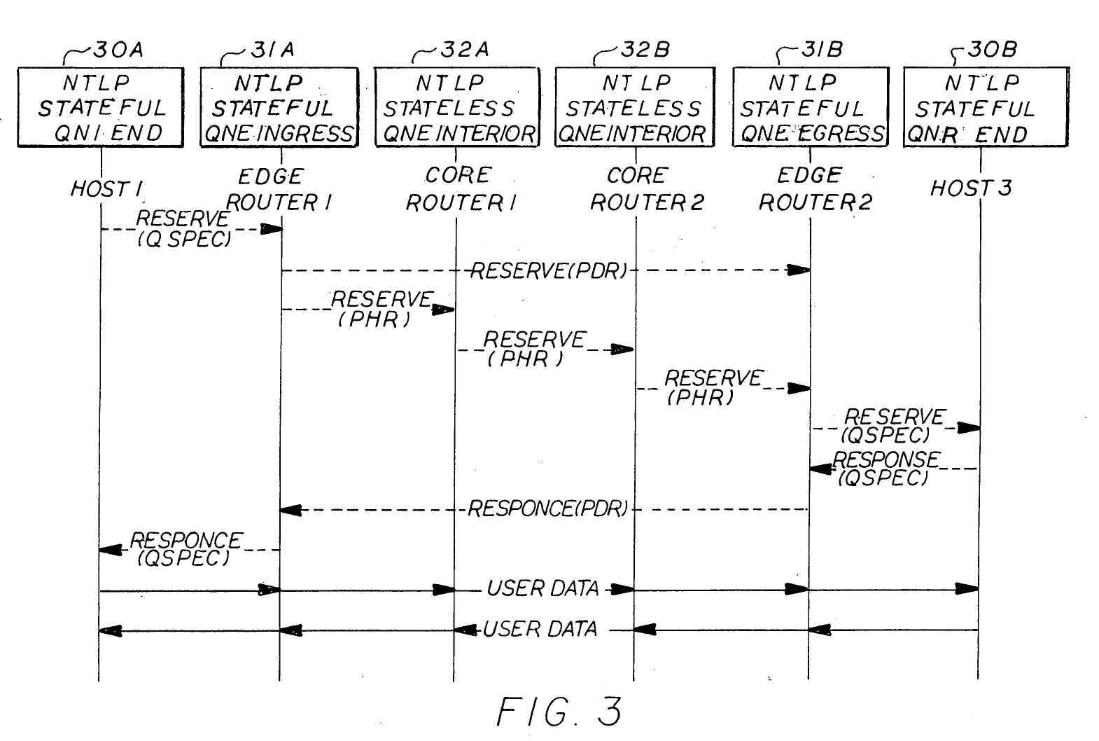

From FIG. 3, End-to-End data flow is being setup by QoS-NSLP nodes 30A, 31A, 32A, 32B, 31B, and 30B, which process intra-domain reserve message against available and required resources. If the reservation is successful in each Interior node 32A and 32B, the egress node 31B forwards original reserve to the next domain. Egress node 31B sends a response message directly to the Ingress node 31A with status. User data is sent after response message is received. Both control & user data packets are encrypted. The control message includes QoS information, which is used to set-up access control list at the core router for priority packet forwarding.

When an external QoS Request arrives at the ingress node 31A, the PDR protocol, after classifying it into the appropriate PHB, will calculate the requested resource unit and create the PDR state. The PDR state will be associated with a flow specification ID. If the request is satisfied locally, then the ingress node will generate the PHR Resource Request and the PDR Reservation Request signaling message, which will be encapsulated in the PHR Resource Request signaling message. This PDR signaling message may contain information such as the IP address, session info the ingress node etc. This message will be decapsulated and processed by the egress node 31B only. The node reserves the requested resources by adding the requested amount to the total amount of reserved resources for that Diffserv class PHB. The egress node 31B, after processing the PHR Resource Request message, decapsulates the PDR signaling message and creates/identifies the flow specification ID and the state associated with it. In order to report the successful reservation to the ingress node 31A, the egress node 31B will send the PDR reservation report back to the ingress node 31A. After receiving this report message, the ingress node 31A will inform the external source of the successful reservation, which will in turn send traffic (user data).

Within a LAN 30A and 30B QoS flags such as ToS, TC, or DS is used for priority packet processing using multi-level priority queues. For QoS service beyond a LAN, 30A sends a quality specification message to interior edge router 31A using a signaling protocol such as NSIS. There are shared encryption keys among edge routers 31A and 31B and core routers 32A and 32B. Intranet side (left side) of the edge router 31A uses signaling protocol (i.e. NSIS) and builds control data; which has a Internet source IP Address, destination IP Address, session ID (optional), and priority Information. Note that this extra step is not required for user data. Both control and user data are based on IP protocols, except control data which also adds signaling protocol and is sent once per session. Once a core router 32A or 32B receives control message, it decrypts the message and adds the tuple with Internet source IP Address, destination IP Address, session ID (optional), and priority information in the access control list (ACL). Note, that core routers are trusted and secured. Once user data passes through core routers 32A or 32B, the core router compares Internet source, destination and optionally Session ID to the ACL list to provide the relevant QoS accordingly.

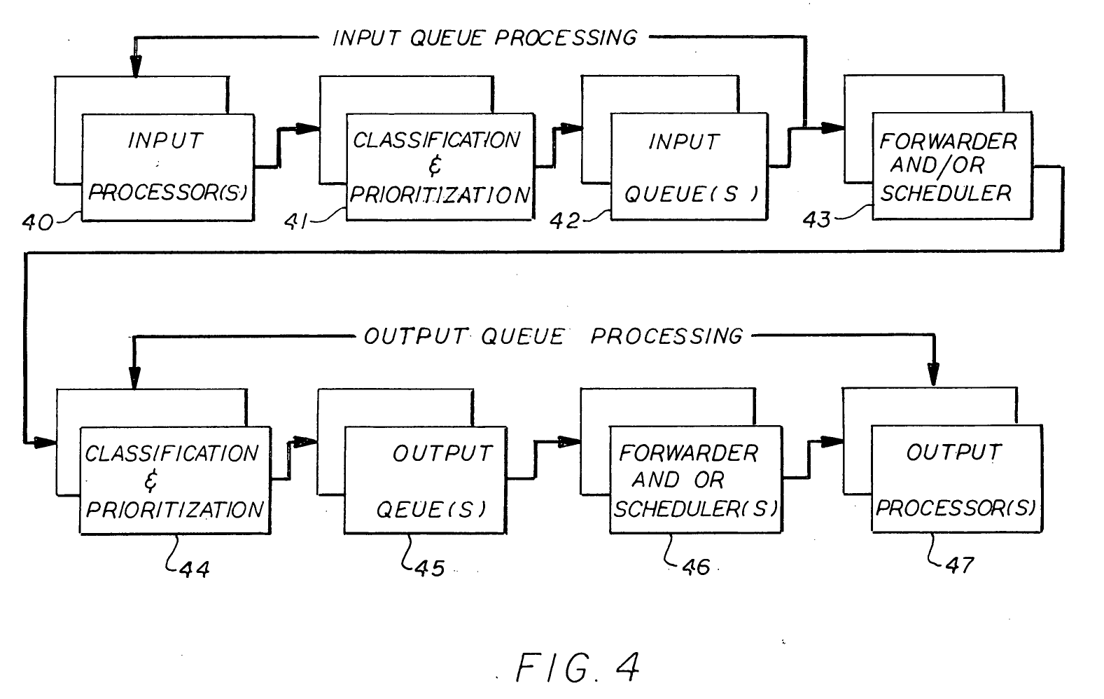

Referring to FIG. 4, packet marking can be accomplished by (a) the input processor or computer 40 itself at the application layer and/or (b) at the nearest network node (router). Packet classification 41, 44 can be done (a) by parsing multiple fields of the IP header (e.g., source/destination, flow label info) or (b) parsing the ToS byte/precedence (e.g., DSCP, precedence bits, QoS info via signaling protocol). Admission Control consists of bandwidth control and policy control. One end point (i.e. a source host) can request a particular QoS for their packets. Scheduling/Queuing 42, 43, 45 and 46 can be assigned to different packets based on their classification.

A process used to process user data is depicted in accordance with a preferred embodiment of the present invention. This process may be implemented in an application, network, and/or link layer. The process begins by receiving a data message to the input processor 40 and ends to the output processor 47. This data message is received after IP packets have received by a lower layer in the protocol and placed into a form for use by the application. The data message is parsed. A determination is made as whether a priority 41 is present within the data message. If a priority is present, then the data message is processed based on the priority indicated with the process termination thereafter. If a priority is absent in the user data message, and then the user data message is processed normally with the process terminating thereafter.

Priority in processing may be achieved by placing the user data message or the data from the user data message higher up in a queue or buffer for processing with respect to other user data messages in which priority is absent or in which priority is lower than that of the current user data message. A similar process is followed by the router at various protocol layers. Upon receiving an IP packet, the router examines the header to see whether an indicator is present or set for priority handling of the IP packet.

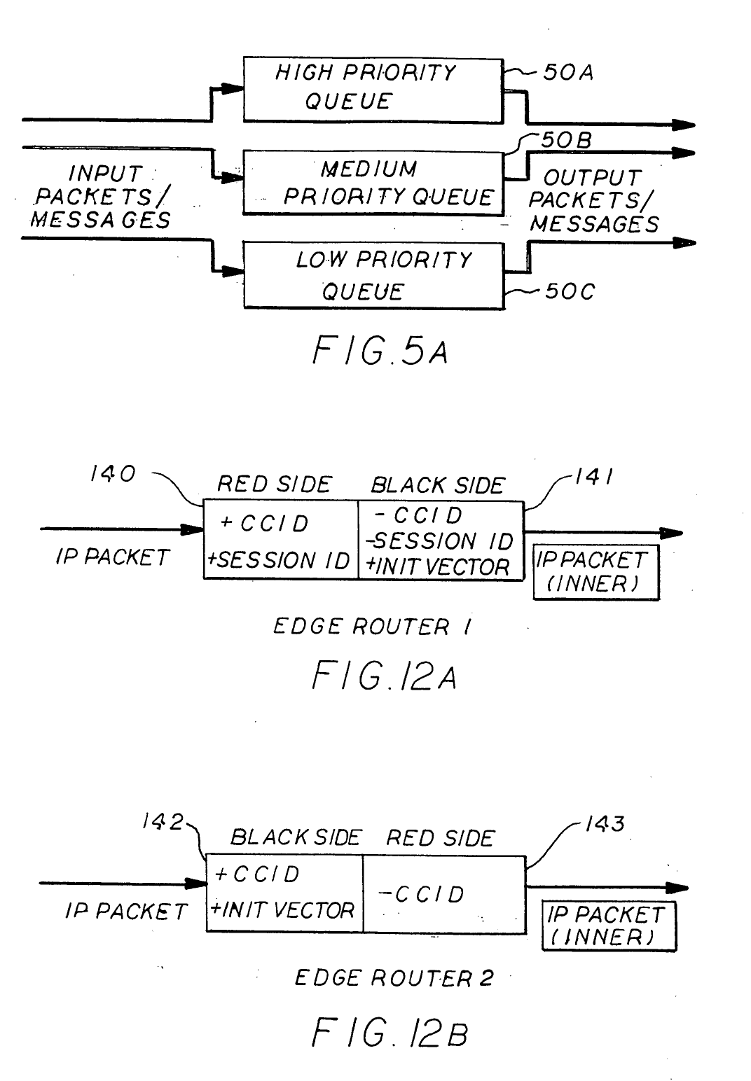

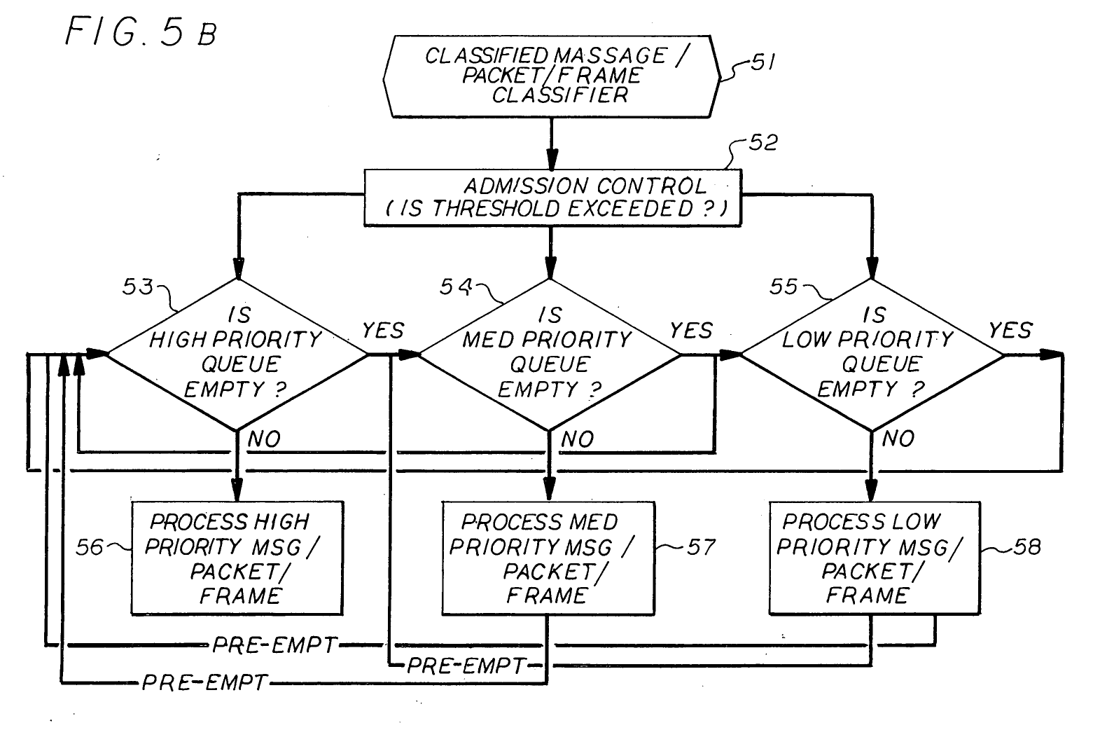

Referring now to FIGS. 5A and 5B, the ready queue can be partitioned two or more position and the queues use pre-emptive priority scheduling algorithms. An example with three priority queues are: high priority queue 50A; medium priority queue 50B; and low priority queue 50C. High priority jobs enters queue 50A, medium priority jobs enters queue 50B, and low priority job enters queue 50C.

Consider a queuing system in which there are three classes of packets classified by classified message/packet/frame classifier 51. The messages have high, med, or low priority, which arrive admission control 52 under independent Poisson distribution. No lower-priority packet enters to be serviced is low priority queue empty 55 with respect to medium priority queue empty 53 with respect to is high priority queue empty 53 when any higher-priority packets are present 54 with respect to 53; and 53 with respect to 54 and 55. If a lower-priority for example [58] packet is in service, its service will be interrupted at once if a higher-priority 53 or 54 packet arrives, and will not be resumed until the system is again clear of higher-priority packets. PQ-WFQ, LLQ or any other priority based queue theory may be applied instead of MPQ depending on the need.

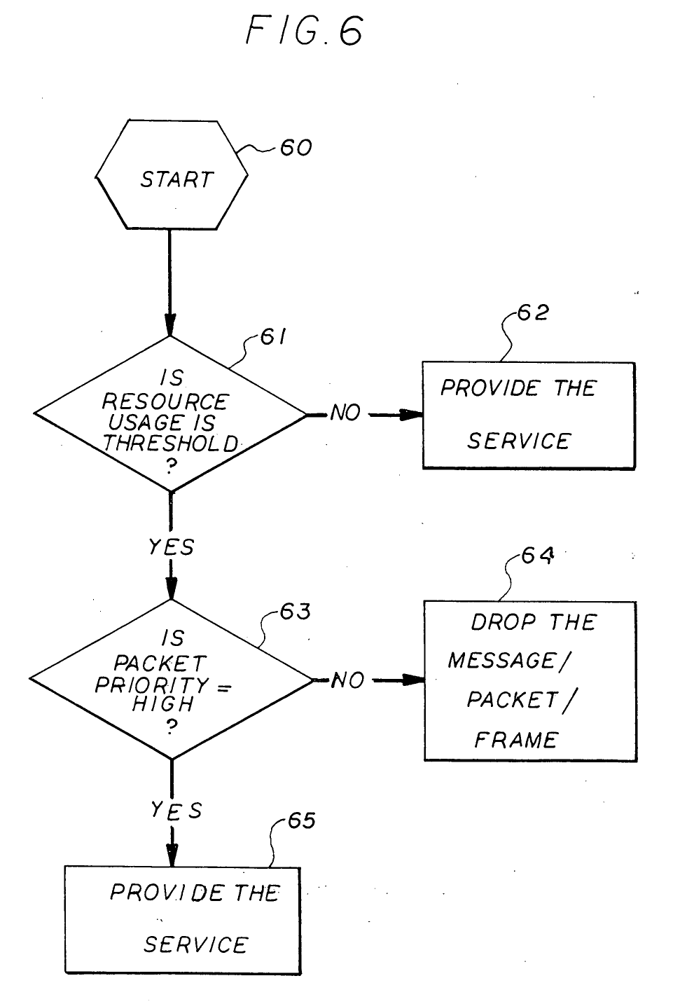

Referring to FIG. 6, which is a flow chart of a admission control (policing) algorithm showing the policy for packet dropping algorithms when the resource bandwidth utilization reaches a predefined or dynamic threshold.
Step 60, resource usage is checked
Step 61 Determine if resource usage is greater than default threshold medium.
If no to Step 62
Step 62 Provide the service
If Step 61 is yes, then to Step 63
Step 63 Determine if packet priority is high. If no to Step 64
Step 64 Drop the message/packet/frame
If Step 63 is yes, then to Step 65
Step 65 Provide the service
Admission control consists of bandwidth control and policy control. Applications terminals can request a particular QoS for their traffic. The devices in the network through which this traffic passes can either grant or deny the request depending on various factors, such as capacity, load, policies, etc. If the request is granted, the application has a contract for that service, which will be honored in the absence of disruptive events, such as network outages.

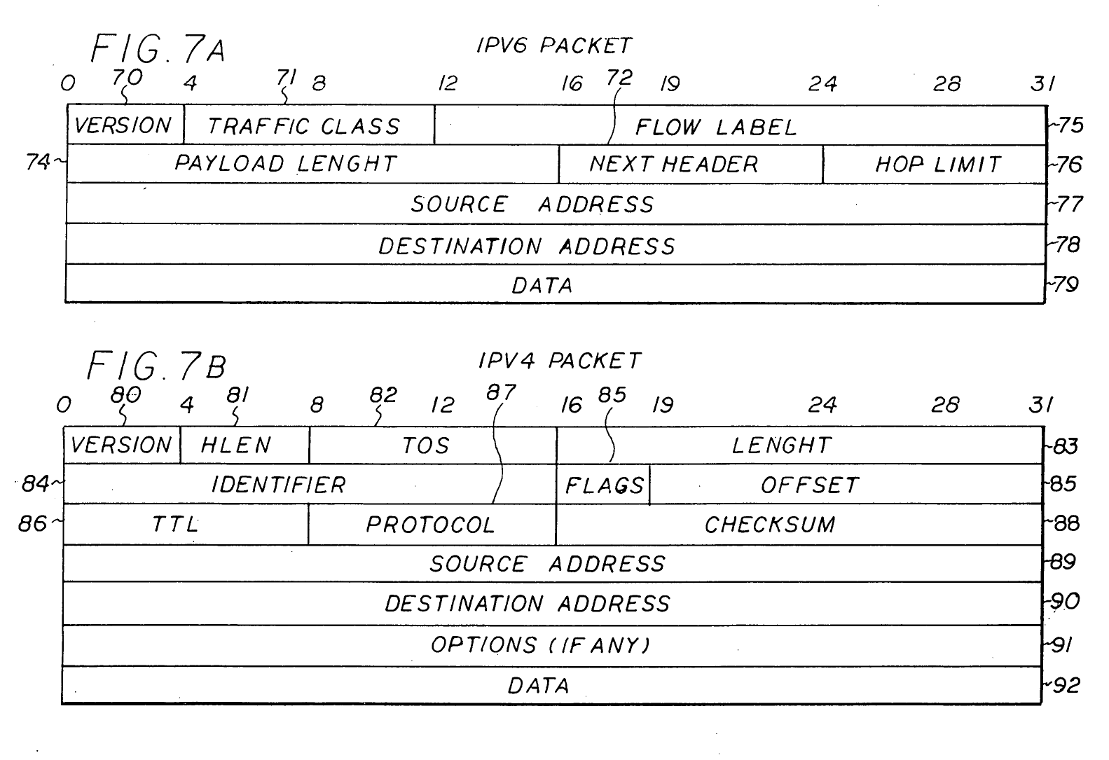

Referring to FIG. 7A, which is pictorial representation of an IPv6 header with payload. The header is the first 320 bits of the packet and contains: 4-bit IP version field 70; 8-bits traffic class field 71 for packet priority; 20-bits Flow Label 75 field for QoS management; 16-bits Payload Length field 74 is in bytes; 8-bits Next Header field 72 is used for the next encapsulated protocol; 8-bits hop limits field 76 is used for time to live information; 128-bits source field 77 and destination field 78 are used for IP address of each; and finally the variable length payload or data field 79. Referring to FIG. 7B is pictorial representation of IPv4 header with payload. The header is consists of 13 fields, of which first 12 are required. The header contains: 4-bits IP version 80; 4-bits Header length 81; 8-bits ToS field 82, which is mainly used for DiffServ and ECN; 16-bits Total Length field 83 defines entire datagram size; 16-bits Identification field 84 is primarily used for uniquely identifying fragments of an original IP datagram; 3-bits flags 85 is used to identify fragments; 13-bits fragment offset field 86 is used to specify offset of a particular fragment; 8-bits time to live field 87 helps prevents datagram to travel unlimited hops; 8-bits protocol field 88 defines the protocol used in the data portion of the IP datagram; 16-bits header checksum 89 is used for error-checking of the header; 32-bits source 90 and destination 91 IP addresses; 32-bits option field 92 is rarely used for optional information; and finally the variable length of payload or data field 93. Both ToS field [82] in FIG. 7B of IPv4 and TC field 71 in FIG. 7A of IPv6 are used in similar manner.

The Type of Service/Traffic Class provides an indication of the abstract parameters of the quality of service desired. These parameters are to be used to guide the selection of the actual service parameters when transmitting a datagram through a particular network. Several networks offer service precedence, which somehow treats high precedence traffic as more important than other traffic. The major choice is a three way tradeoff between low-delay, high-reliability, and high-throughput. The use of the delay, throughput, and reliability indications may increase the cost of the service. In many networks better performance for one of these parameters is coupled with degraded performance on another. Except for very unusual cases at most two of these three indications should be set. The type of service is used to specify the treatment of the datagram during its transmission through the internet system.

The network control precedence designation is intended to be used within a network only. The actual use and control of that designation is up to each network. The Internet-work control designation is intended for use by gateway control originators only. If the actual use of these precedence designations is of concern to a particular network, it is the responsibility of that network to control the access to, and use of, those precedence designations.

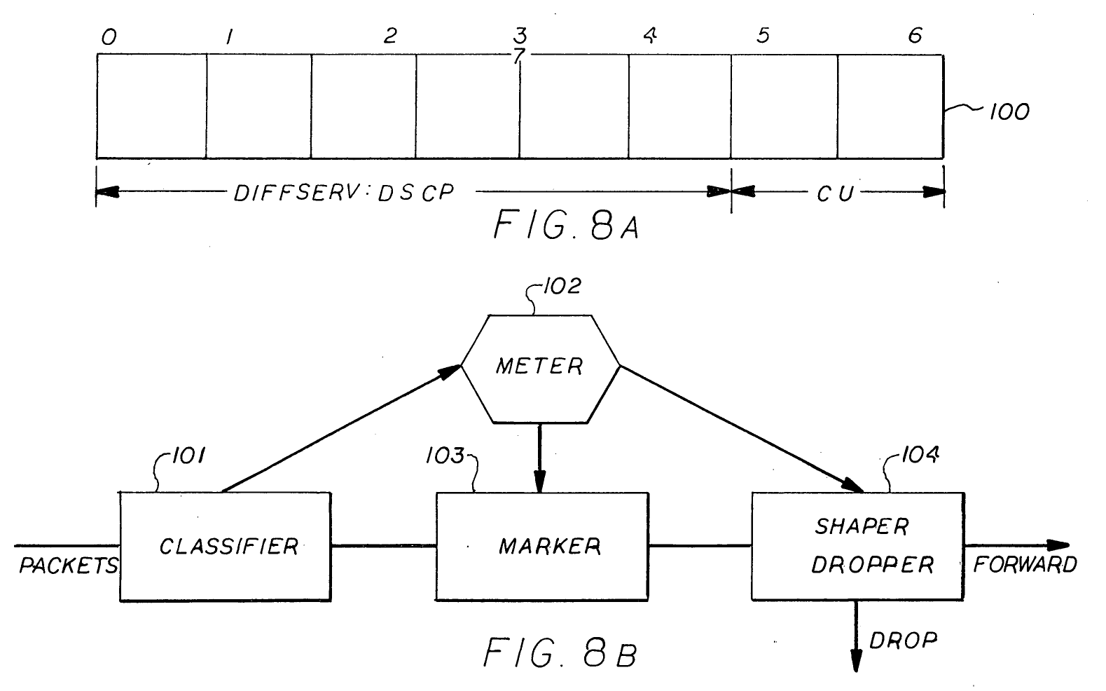

Referring to FIG. 8A, differentiated services (DS), indicated by numeral 100 is used among edge and core routers, where edge routers/hosts provide complex routing functions and core routers provide simple functions. The edge router functions reside at DS-capable host or first DS-capable router. The edge node marks packets according to classification rules set-up by the administrator or service level agreement via RMD or other signaling protocol. This edge node may delay and then forward or may discard packet based on classification. The core routers provide Per-Hop-Behavior (PHB) specified for the particular packet class; such PHB is strictly based on class marking/forwarding.

A diagram of an IP packet (see FIG. 4) is depicted in accordance with a preferred embodiment of the present invention. IP packet includes a header and a payload. Payload contains an entire user data message. To provide for priority handling of the user data message contained within IP packet by nodes in which an application processing user data messages is absent, an indicator is set within header of IP packet. In the depicted examples, a DS field 100 is set to provide priority or precedence for the handling of IP packet by nodes, which do not examine the user data message in the processing of IP packet. In accordance with a preferred embodiment of the present invention, this field is set by a network layer, in response to a call from an application in an application layer within the protocol stack. In particular, the DS field is set to provide for priority or precedence handling of user data messages placed into IP packets routed by nodes, such as routers, which do not examine the user data message itself when routing the IP packets. When the DS field is set, a node receiving IP packet will provide priority handling for the packet. In the depicted examples, packets, such as an IP packet, are typically placed into a queue for processing or routing to another node. Referring to FIG. 8B the edge router may classify 101, meter 102, mark 103 and shape 104 non-conforming traffic packets, meaning the packets which do not follow in the above mentioned pattern in order to provide priority treatment.

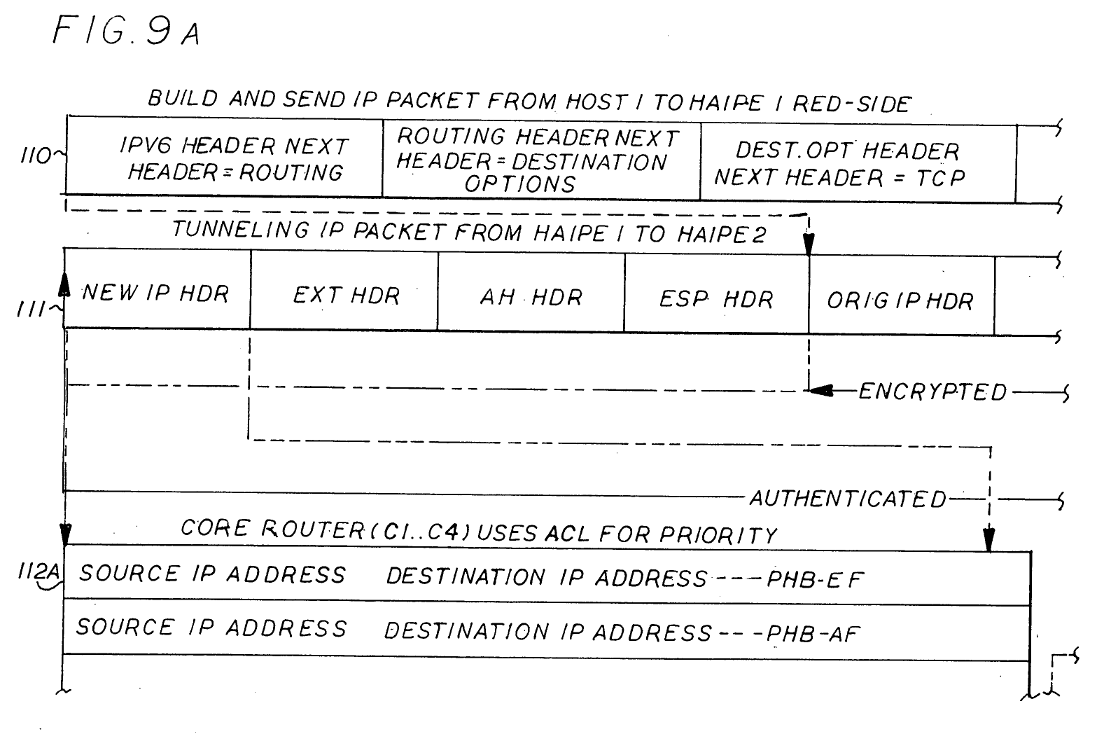

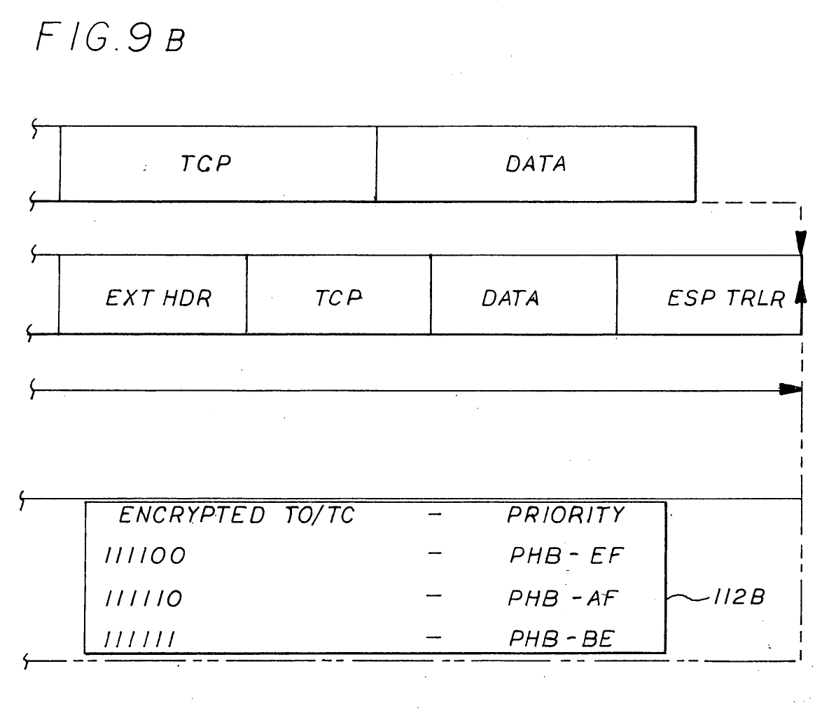

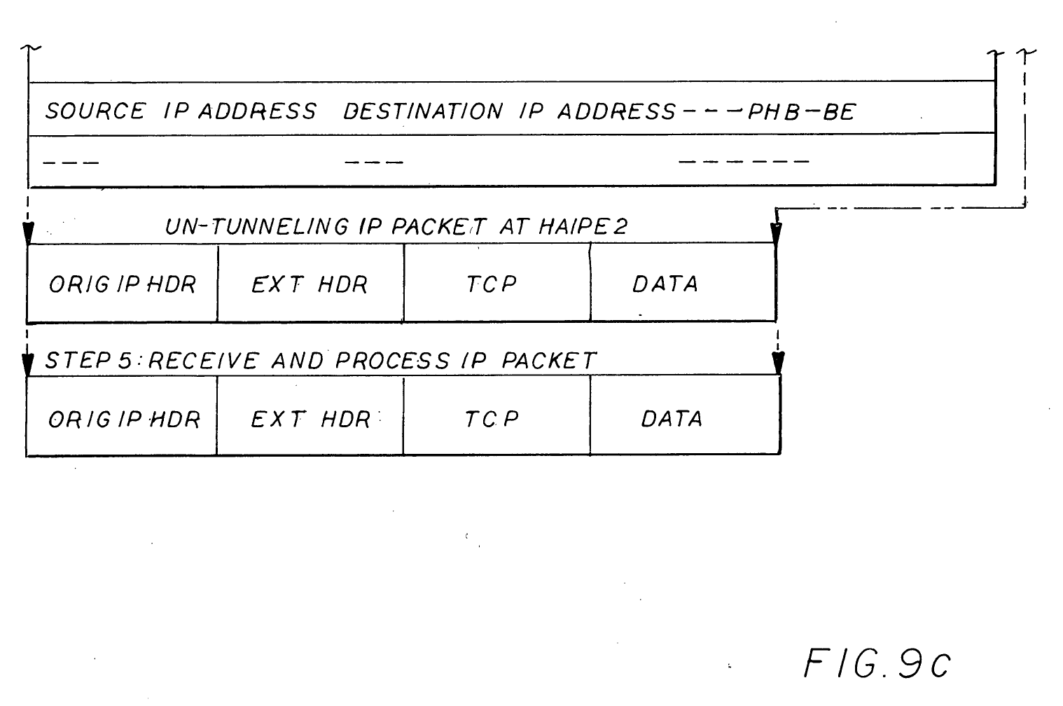

Referring back to FIG. 1 and additionally to FIG. 9:
In Step 110—The source computer 10A builds and sends an IP Packet to a router in this case a router (HAIPE) 12A or any router intranet-side (inner site to the LAN), where the source IP address is set to source computer 10A IP address, destination IP address is set to router 12A intranet-side (inner side to the LAN) IP address, and routing header extension has destination computer 10B IP address.
In Step 111 router 12A uses IP tunneling protocols between itself and HAIPE 12B. The new packet is initialized as follow. Inner IP destination is set to computer 3 10B IP Address, which information is copied from routing header. Afterwards the source router (in this case router 12A) perform encryption on the packet, where source IP address is set to Internet interface address of HAIPE1, destination IP address is set to Internet interface IP address of router 12B. At one instance of the configuration source and step 112A, the routers can make up three or more unique source-destination IP address, which can be used to route various priority packets. In another instance 112B it has only one unique source/destination IP address, where the ToS/TC field is encrypted. First encryption is applied from original IP Header to Encapsulated Security Payload (ESP) trailer and authentication is applied from new IP header to ESP trailer.
In step 112A, core routers 13A, 13B, 13C, 13D use access control list (ACL) in order to provide packet priority between two gateways. In another instance 112B the outer ToS/QoS field is encrypted with a random number. Source Core Router shares one or more random number(s) along with a session key (optionally) with its peers. Therefore at the destination gateway, the encrypted random number is compared with the received encrypted ToS/QoS field in order to process the packet in the correct priority.
In step 113, the destination HAIPE/Router un-tunnels the IP Packet. Then the HAIPE/Router performs packet decryption, and forwards to the final destination Host.
In step 114, the computer 12B, receives the packet and processes according to the packet priority. Optionally computer to computer data security can be achieved using separate encryption policy.

User data may be, for example, a message to set up a session, a message to terminate a session, and a message to authenticate/authorize a user. User data includes a header and a payload in these examples, user data messages is placed into a queue for processing by an application. Application layer identifies time sensitive user data and a priority is generated. Additionally, a call is made to an IP layer in the protocol to set the priority indicator. The priority indicator set in response to this call is a priority indicator in a header of the packet used to transport the user data message. In the depicted examples, this priority indicator is a DS field 100. This call is used to provide priority handling of packets used to transport user data messages. The setting of this indicator allows for priority handling of the packet in nodes, which do not examine user data messages. In this manner, best efforts handling in the transport of the user data message from a source to a destination is ensured even when the message is being transported through nodes, which do not look at the contents of the packets themselves. The user data message is then sent for transport with the process terminating thereafter. This step involves sending the user data message to the next layer in the protocol stack, such as a transport layer. The setting of an indicator in the header of an IP packet and the use of a mechanism to reserve bandwidth for processing selected packets is intended as examples of mechanisms used to provide best efforts processing of user data. Ethernet layer can process similar priority as needed.

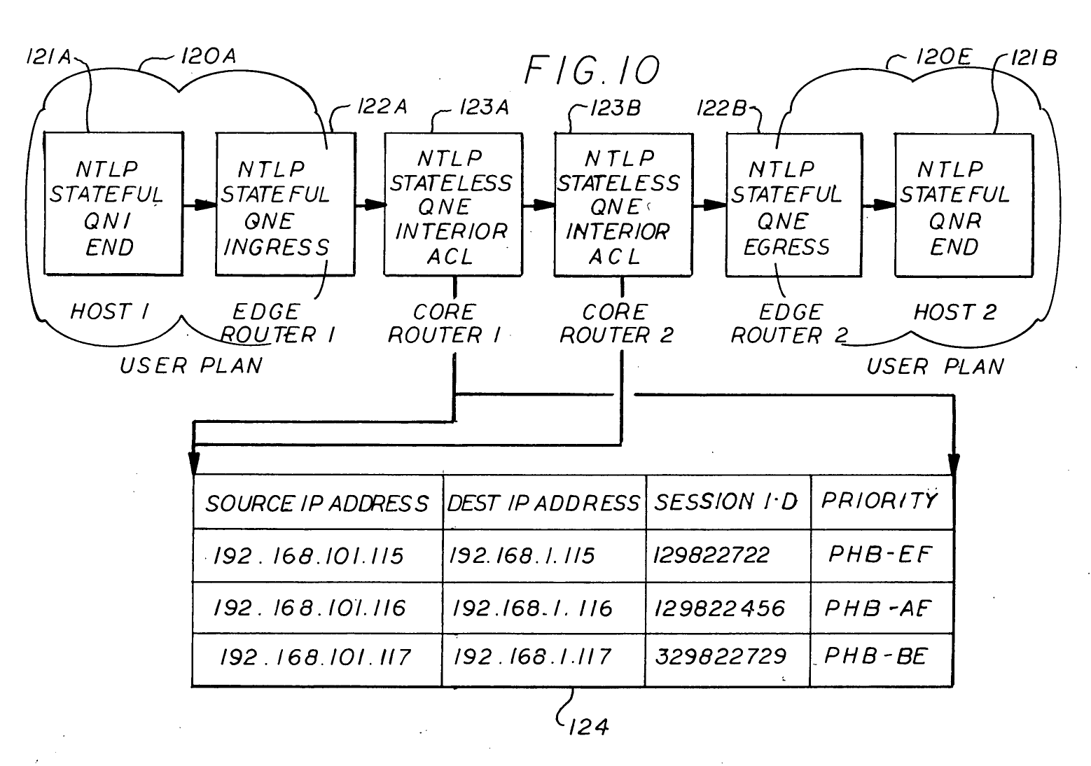

In FIG. 10 core router functionality with respect to control message processing is described. IPv6 allows any interface to have multiple IPv6 address'. This is accomplished by providing a link with multiple subset prefixes, while keeping the same Interface ID. Also the same Interface ID may be used on multiple interfaces of the same node, for as long as they have different subnet prefixes.

Referring to FIG. 10, a LAN 120A includes a control message generated by the computer 121A via Edge Router 122A destined to the computer 121B in LAN 120B, via edge router 122A through core routers 123A and 123B and edge router 122B. The encrypted control message contains information to build an access control list (ACL) to provide IP packet priority control at the Core Routers 123A and 123B. The ACL tuple 124 contains source IP address 124A, destination IP address 124B, session ID124C (optional), and priority Information 124D. Core routers 123A and 123B receive an encrypted control IP message via signaling protocol such as next step in signaling (NSIS) signaling layer protocol (NSLP). Core routers 123A and 123B decrypt the control message. Router 123B extracts source IP address, destination IP address, session ID and priority information (QoS) from IP Packet. The core routers 123A and, 123B adds a tuple 124 in the ACL table in order to processing user data associated for that session.

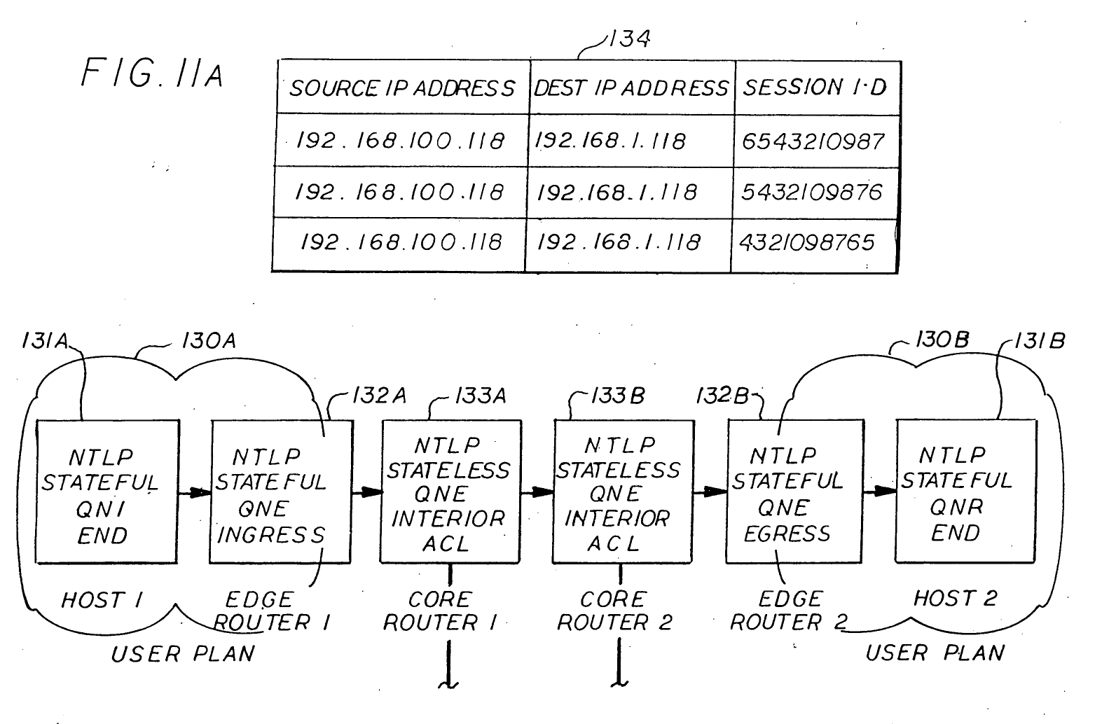

Referring to FIG. 11, core routers 133A and 133B functionality with respect to user data message processing is described. In LAN 130A, user data message generated by the computer 131A, via edge router 132A destined to the computer 131B, in LAN 130B, via edge router 132B through Core Routers 133 and 133B. User IP packet flows into a core router 133A and egresses on another core router 133B or edge router 132B as shown. The ACL 134 contains source IP address 134A, the destination IP address 134B, and Session ID 135C (optional, in the flow level field) copied from intranet Session ID or is mapped. This information is matched against the ACL 135 to provide QoS to the user data packet. Core routers 133A and 133B receives a user IP packet. Source IP address, destination IP address, and session ID (optional) in IP packet are examined against the ACL 135. Core routers 133A, and 133B process/forward IP packet to another core/edge router using the QoS specified in the ACL 135. IP packet is framed through lower layer framer and sent towards the destination IP address.

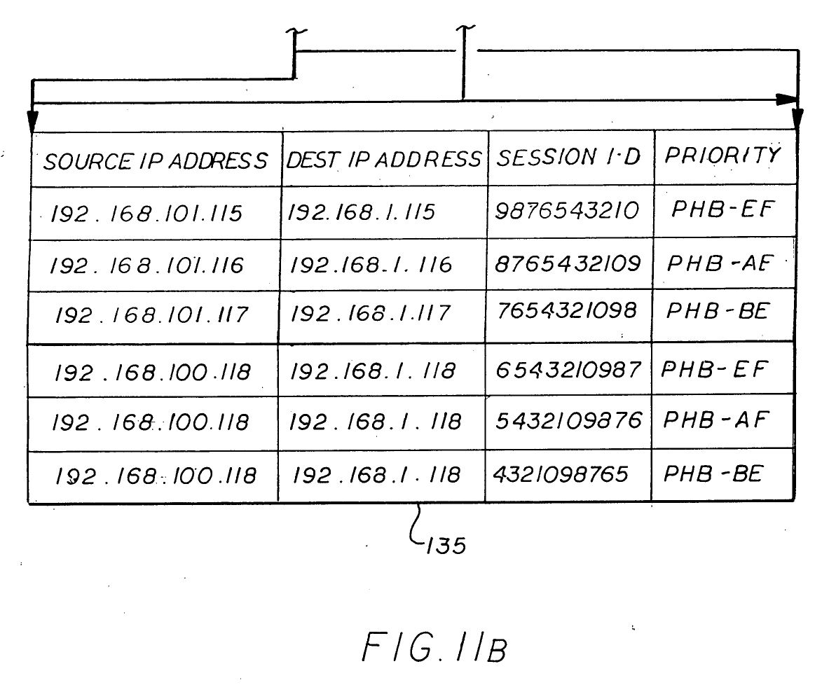

Referring to FIG. 1 and additionally to FIG. 12A the edge router 12A processing from the side of the edge router, which is interfacing with the computer inner side 10A (red side) 140 to the side of the edge router 12A, which interfaces with the core router 12A (Internet side) 141. The intranet side 140 of the edge router12A receives packet (control packet and user data packet) from LAN. The edge router12A processes the IP packet based on the ToS/TC/DS information. A crypto control identification (CCID) and session ID (optional) tags are added that is configured to be associated which creates a virtual channel between an intranet side IP Address and a Internet IP address. Edge Router 12A receives an IP Packet on an intranet side. The ToS/TC/DS field in IP packet is examined. CCID and Session-ID tags are added to IP Packet destined to a GIG IP address. INFOSEC initialization vector is added in the information security (INFOSEC) module, (optional). The session-ID is copied to the outer TC/ToS/DS/Flow Label Field. The IP packet is encrypted and routed through the INFOSEC based on the CCID. The CCID bridges the IP packet from the ingress IP Address to the egress IP address of the INFOSEC module. The CCID is removed and lower layer framing is performed and routed.

Referring to FIG. 12B, at edge router 12B the Internet side 142 to intranet side 143 processes, the ingress lower layer frame so that it is received and de-framed. The INFOSEC receives the IP Packet and decrypts the IP Packet and removes the initialization header. On egress from the INFOSEC the CCID tag provides a virtual connection from an Internet IP address to an intranet IP Address. Encrypted IP packet with destination IP address is received from a core router. The lower layer de-framer removes lower layer sync from the packet. CCID tag is added to the IP packet for the INFOSEC. INFOSEC decrypts the IP packet based on the CCID tag. INFOSEC processing removes the initialization vector (optional). IP Packet forwarded to computer based on the Destination IP Address and TC/ToS/QoS.

A node (i.e. router, host, server, etc) in which the present invention may be implemented is depicted in accordance with a preferred embodiment of the present invention. In this example, a node contains a bus providing communication between processor unit, memory, communications adapter, and storage. The processor unit, in this example, executes instructions, which may be located in memory or storage. Communications adapter is used to send and received data, such as user data messages. Node may be used to implement different components of the present invention. For example, a node may be a host or a router used to route IP packets or communications unit used to route or handle user data messages within a packet-based network, such as IP network.

This present invention provides a priority based mechanism used to control and user data within a packet-based network. Control and user data contain time sensitive information that is sensitive to delays in delivery. The mechanism of the present invention allows for these types of control and user data messages to be appropriately handled when received via different nodes. The priority handling is provided through the setting of various indicators within the messages and packets by the various protocol layers. The processing of messages and IP networks can be handled securely and quickly to avoid delays in delivering data to delay sensitive applications.

This description of the present invention has been presented for purposes of illustration and description and is not intended to be exhaustive or limited to the invention in the form disclosed. Many modifications and variations will be apparent to those of ordinary skill in the art. For example, although the depicted examples use user data messages, the processes of the present invention may be implemented for other types of data other than user data including control and user data.

### INDUSTRIAL APPLICABILITY

This invention has applicability to the computer network operation, cyber security, and information assurance industry.

1. A process for prioritizing messages from a first computer system having at least one computer connected to a first edge router to be sent to a second computer system having at least one computer connected to a second edge router, the process includes the steps of:
providing priority status from at least one first computer to the first edge router;
determining the priority status of the message by the first edge router;
prioritizing the sending of the message by the first edge router;
encrypting the priority status prior to sending the message to at least one second computer at the selected priority status; and
upon receiving the encrypted message, the second edge router decrypts the priority status of the message and sends it to at least one second computer at the selected priority status.

2. The process as set forth in claim 1 herein:
the priority status is encrypted by at least one first computer; and
the first edge router de crypts the priority status of message to determine priority status.

3. The process as set forth in claim 1 wherein encryption of the priority status is accomplished by the first edge router.

4. The process as set forth in claim 2, or 3 wherein in packet classification can be accomplished by the following processes selected from the group consisting of parsing multiple fields of the IP header, flow label information, and parsing the ToS byte/precedence.

5. The process as set forth in claim 4 comprising
admission Control consists of bandwidth control and policy control;
applications terminals request a particular QoS for their traffic; and
scheduling and queuing are assigned to different packets based on their classification.

6. The process as set forth in claim 5 wherein the priority status comprising a queuing system in which there are at least two classes of packets and no lower-priority packet enters to be serviced when any higher-priority packets is present; and
if a lower-priority packet is in service, its service will be interrupted at once if a higher-priority packet arrives, and will not be resumed until the system is again clear of higher-priority packets.

7. The process as set forth in claim 3 wherein QoS can be applied in the group consisting of: application layer for message queuing, or applied in the network layer for IP packet queuing, or applied in the link layer for Ethernet frame queuing.

8. The process as set forth in claim 5 wherein
encrypted Traffic Class or ToS or DSCP field is used to carry Internet traffic priority delivery value;
the flow label field is used for specifying special router handling from source to destination(s) for a sequence of packets;
the source address field is used to contain source address of the sending node; and
the destination address field is used to contain address of the destination node.

9. A process for prioritizing messages from a first computer system having at least one computer connected to a first edge router to be sent to a second computer system having at least one second computer connected to a second edge router, and the above two edge routers are connected via at least one core router includes the steps of:
the source computer builds and sends IP packet to the first inner side of the edge router;
the edge router providing and encrypted priority status message to the core router;
decrypting the priority status of the message at the core router;
de-encrypting the priority status message at the core router; and
sending the message based on its priority status to other core or edge router if no more core router exist.

10. The process as set forth in claim 9 wherein
packet marking is accomplished by either the host itself at application layer and/or (b) at the nearest network router;
packet classification is accomplished by the process consisting of: can parsing multiple fields of the IP header or parsing the ToS byte/precedence;
admission Control is accomplished by bandwidth control and policy control;
QoS is accomplished by application terminals can for their traffic; and
scheduling/queuing is assigned to different packets based on their classification.

11. The process as set forth in claim 10 wherein
a queuing system in which there are three classes of packets—high, med, and low priority, which arrive under independent Poisson distribution;
No lower-priority packet enters to be serviced when any higher-priority packets are present; and
If a lower-priority packet is in service, its service will be interrupted at once if a higher-priority packet arrives, and will not be resumed until the system is again clear of higher-priority packets.

13. The process as set forth in claim 12 wherein QoS is applied by the process consisting of the application layer for message queuing; in the network layer for IP packet queuing; or in the link layer for Ethernet frame queuing.

14. The process as set forth in claim 13 wherein admission control consists of bandwidth control and policy control;
applications terminals request a particular QoS for their traffic;
usage of resource is checked and if usage of resource is greater than the default threshold, the medium and low priority packets will be dropped;
the new packet will be processed when its priority is high; and
the devices in the network through which this traffic passes can either grant or deny the request depending on capacity, load, policies.

14. The process as set forth in claim 13 wherein
internet traffic priority delivery value is carried by encrypted traffic class or the ToS or the DSCP;
the flow label field is used for specifying special router handling from source to destination) for a sequence of packets;
the source address field is used to contain source address of the sending node;
the destination address field is used to contain address of the destination node.

15. The process as set forth in claim 14 wherein
the source computer builds the message, the source IP address is set to source computer IP address, destination;
the IP address is set to the inner side of the edge router's IP address, and routing header extension has destination computer's IP address;
source edge router uses IP tunneling protocols to destination edge router, where inner IP destination is set to destination computer's IP Address;
the source edge router performs encryption on the packet, where source IP address is set to outer interface address of source edge router, and destination IP address is set to outer interface IP address of destination edge router;
core routers use access control list in order to provide packet priority between two gateways;
the destination edge router un-tunnels IP Packet, performs IP packet decryption, and forwards it to the destination host; and
The destination host receives the packet and processes according to the packet priority.

16. The process as set forth in claim 15 wherein
first encryption is applied from original IP header to encapsulated security payload trailer; and
authentication is applied from new IP header to encapsulated security payload trailer.

17. The process as set forth in claim 16 wherein the configuration of source and destination edge routers makes up three or more unique source-destination IP address, which can be used to route various priority packets or it has only one unique source/destination IP address, where the ToS/TC field is encrypted; or the outer ToS/QoS field is encrypted with a random number, and source core router shares one or more random number along with a session key with its peers, and at the destination gateway, the encrypted random number is compared with the received encrypted ToS/QoS field in order to process the packet in the correct priority.

18. The process as set forth in claim 17 wherein security of data between source and destination computers can be achieved using separate encryption policy.

19. The process as set forth in claim 18 wherein
the edge router receives an IP Packet on the input side interface of the router,
the ToS/TC/DS field in IP packet is examined;
The CCID and Session ID tags are added to the IP Packet to be send to a GIG IP Address;
INFOSEC initialization vector is added in the INFOSEC module;
session-ID is copied to the outer TC/ToS/DS/flow label field;
the IP Packet is encrypted and routed through the INFOSEC based on the CCID;
the CCID bridges the IP packet from the ingress IP Address to the egress IP address of the INFOSEC module; and
the CCID is removed and lower layer framing is performed and routed.

20. The process as set forth in claim 15 wherein the core router receives an encrypted control IP message via signaling protocol;
the core router decrypts the control message;
the core router extracts source IP address, destination IP address, session ID and priority Information (QoS) from the IP packet; and
the Core Router adds a tuple in the ACL table in order to processing user data associated for that session.

21. The process as set forth in claim 20 wherein
the core router receives a user IP packet;
the source IP address, destination IP address, and session ID in IP Packet are examined against the ACL;
the core router process IP packet to another core/edge router using the QoS specified in the ACL; and
the IP packet is framed through lower layer framer and sent towards the destination IP address.

22. The process as set forth in claim 21 wherein
the encrypted IP packet with destination IP address is received from a core router;
the lower layer de-framer removes lower layer sync from the packet;
the CCID tag is added to the IP Packet for the INFOSEC;
the INFOSEC decrypts the IP packet based on the CCID tag;
the INFOSEC processing removes the initialization vector; and
edge router forwards the user data to the destination host for processing.
